(19) United States
(12) Patent Application Publication
(10) Pub. No.: US 2013/0257072 A1
(43) Pub. Date: Oct. 3, 2013

(54) Cane and Crutch grasping device

(71) Applicant: Jimmie Dale Chrysler, Wyoming, MI (US)

(72) Inventor: Jimmie Dale Chrysler, Wyoming, MI (US)

(21) Appl. No.: 13/438,033

(22) Filed: Apr. 3, 2012

(51) Int. Cl. B25J 15/00

(52) U.S. Cl. 294/116

(57) ABSTRACT

An attachment for use with a walking cane or crutch to facilitate picking up objects from the surface. The attachment is designed to attach to most walking canes and crutches without modifying the original design walking aide, having a unique adjustment system that enables use on adjustable style walking aides. Includes a trigger mechanism located under the hand grip, actuating a pivotal arm mechanism located along the side of the cane tip, and away from the operator walking side, the pivotal arms are stored in the vertical position and rotate down, to 180 degrees to clamp on objects at ground level. The parts and mechanism are designed to be symmetrical and may be positioned on either side for right hand or left hand use. Although pictured with an offset cane it is designed to be used with a straight shafted cane and also crutches.

### BACKGROUND TO THE INVENTION

### 1. Field of the Invention

The invention relates to a grasping device for use with walking support equipment such as canes and crutches. This device is capable of picking up items from the surface.

2. Summary of the Related Art

Some individuals with walking disabilities who require a cane or crutch, lack the ability to bend down to pickup objects from the surface, Many patents have been filed for use with canes that enable an individual to grasp items from the surface, some requiring machining and permanent mounting to the cane, this device can be easily mounted to, not only a cane or crutch but does not require modification of the cane and may be re-used on other canes or crutches.

### PRIOR ART

U.S. 2012/0,060,878 A1. Features a cane with a remotely operated jaw that closes on the cane tip, it has a locking trigger to hold the jaw out of the way to be used as a cane.

U.S. 2012/0,067,385 A1 features c telescoping cane and does not have any grasping arms.

U.S. 2012/0,031,447 A1 features a cane with adjustable hand grips.

U.S. Pat. No. 8,122,900 B1 features a cane with internal jaws

U.S. Pat. No. 7,624,746 A1 features a grasping cane with a remotely controlled by a trigger at the handle but must collapse the jaw against the cane tip, it also requires the cane to be modified.

U.S. Pat. No. 7,527,311 B2 is an internal spring loaded picker attached to a cane.

U.S. Pat. No. 7,281,470 B1 is another internal spring loaded pickup device attached to a pole.

U.S. Pat. No. 7,243,668 B1 uses a trigger to move a jaw against the cane tip but requires modification to the cane.

U.S. Pat. No. 6,550,490 is a cane using a grasping jaw to close against the cane tip. This one however; mounts to the side of a cane using special clamps without requiring modification to the cane.

U.S. Pat. No. 5,433,234 is a cane using a lever mounted below the handle to drive a scissor type grasping device at surface level. The device uses a clamping system to attach it to the cane.

U.S. Pat. No. 5,222,973 is a medical grasping device to remove objects inside a patient.

U.S. Pat. No. 4,827,956 is a motorized grasping device.

U.S. Pat. No. 4,811,750 is a gripping device from the bottom of the cane tip, but requires modification to the cane.

U.S. Pat. No. 4,575,143 is an internal spring loaded pickup device but not useful in a cane.

U.S. Pat. No. 4,056,278 is an internal spring loaded gripping device that extends grippers from the bottom of a modified cane.

U.S. Pat. No. 3,844,291 is a simple gripping device but not useful with a cane.

U.S. Pat. No. 3,409,402 is an internally operated gripping device where the cane tip must be removed to use the grasping arms.

U.S. Pat. No. 2,891,811 is a bait catcher that uses an internally mounted trigger assembly to operate a grasping arm against the foot of the cane.

U.S. Pat. No. 2,669,896 is another internally mounted grasping device.

### BRIEF DESCRIPTION OF THE DEVICE

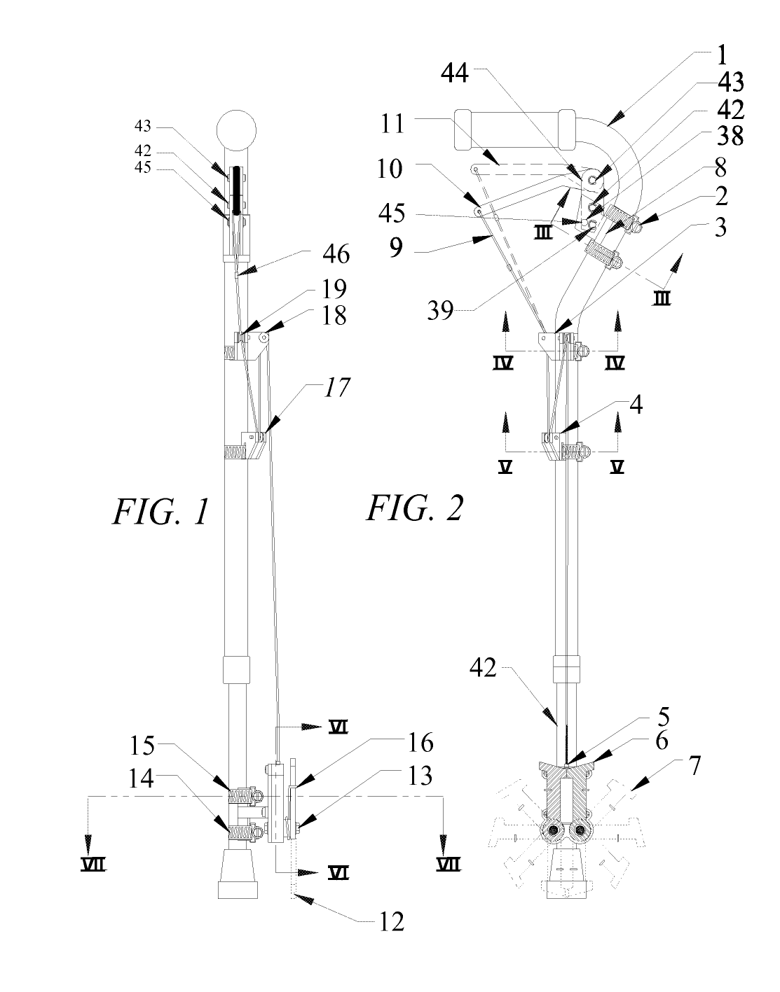

FIG. 1 is an end view of a cane picturing how the device is mounted along the side of the cane and away from the walker with right handed use, since all the parts are symmetrical the device may be mounted on either side of the cane and away from the walker with left handed use too, since all the parts are symmetrical the device may be mounted on either side of the cane.

FIG. 2 is a side view of an offset cane and attached apparatus of FIG. 1, taken as indicated by section lines III through the first mounting attachment.

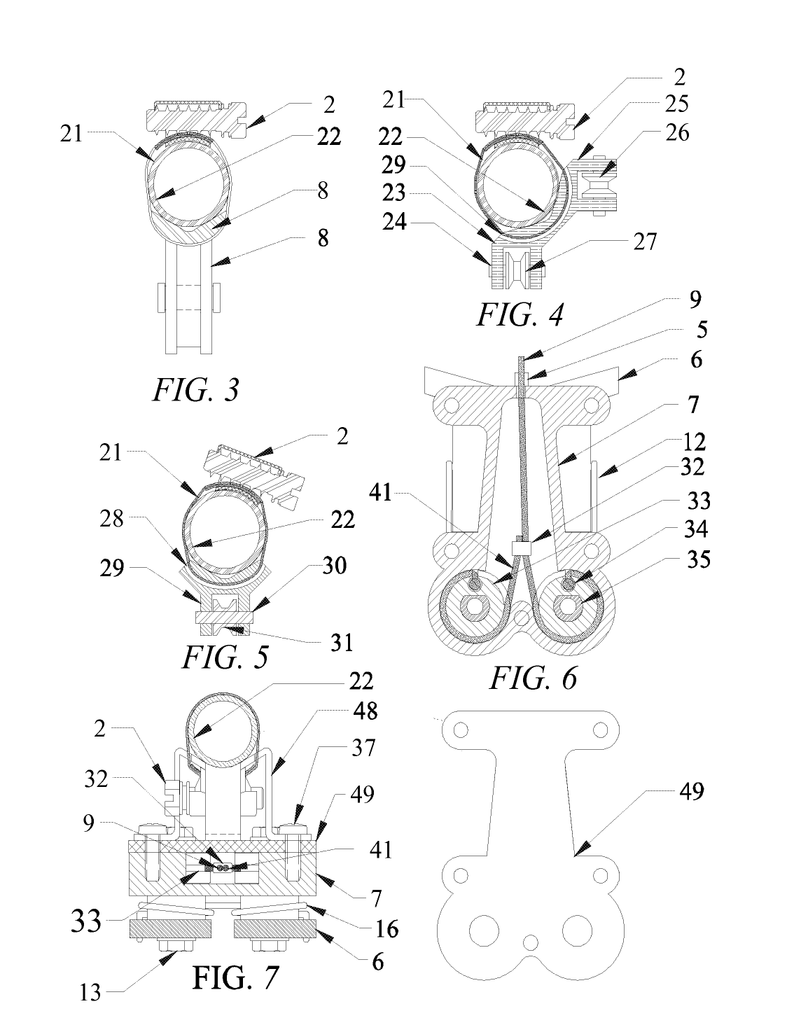

FIG. 3 is a sectioned mounting view of the trigger (11) assembly of FIG. 2, showing a sectioned view III of the trigger mount and hose clamp.

FIG. 4 is a sectioned mounting view of FIG. 2 showing the cross section of the mounting bracket IV, for a double pulley bracket (3) that works with a single pulley adjustable bracket (4), FIG. 5, to enable adjusting for height change or slack in the operating cord.

FIG. 5 is a sectioned mounting view of a pulley bracket V, to be mounted at about 45 degrees between and below the FIG. 4 double pulley to be adjustable up or down to adjust for height changes or slack of the trigger cord.

FIG. 6 is the cross section of the main device body VI showing how the arms of the device is rotated by lifting the trigger (11) attached to the cord (9).

FIG. 7 is a cross sectional view of the mounting bracket (48) FIG. 12, that clamps the device body VII to the adjustable leg of the cane or crutch using (2) hose clamps.

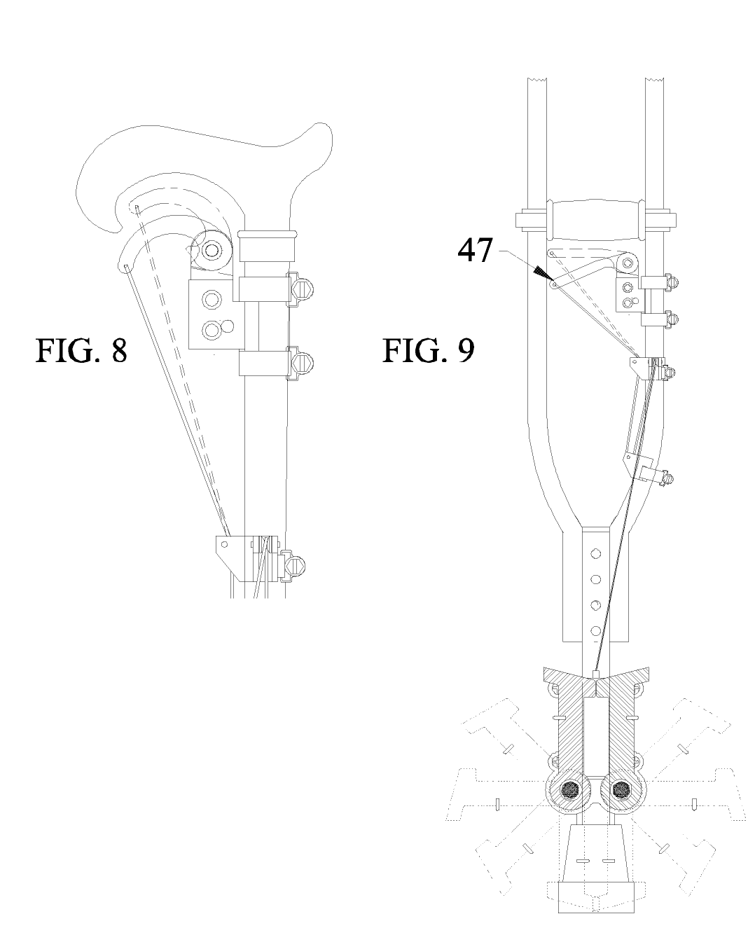

FIG. 8, is a side view of a straight shafted cane with a curved trigger (46) and the clevis (44) mounted in the vertical position using hole (45) with pin (39).

FIG. 9, is a side view of a crutch with a straight but shorter trigger (47).

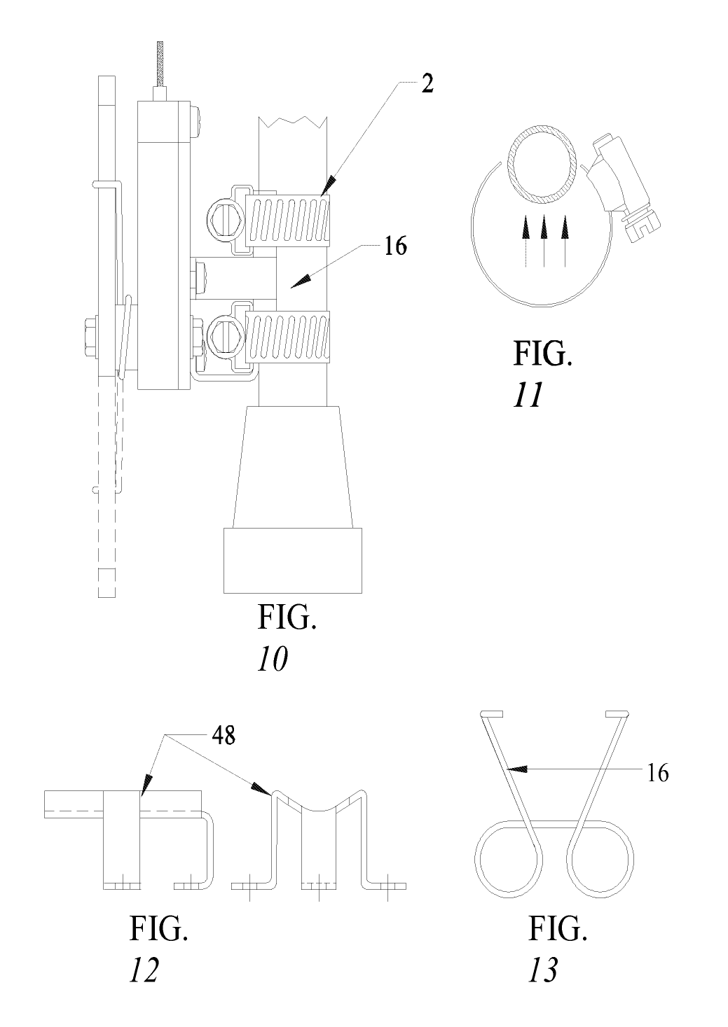

FIG. 10, pictures how the rotating device is assembled to the shaft.

FIG. 11, shows how the hose clamp can be opened enough to be assembled over a shaft and be re-assembled by re-inserting the open end of the band and screwed to tighten the clamp on a shaft.

FIG. 12 pictures the detail of the mounting bracket (48).

FIG. 13 is how the torsion spring will look with the arms in the upper, at rest, position.

### DETAILED DESCRIPTION OF THE INVENTION

FIG. 1 is an end view of a cane (1) which may be a conventional type, either an offset handle FIG. 2 or a straight handled cane FIG. 8, or a crutch FIG. 9, used to enable physical stability for a walker. In addition this device (41) enables such persons to pickup items from the surface without bending which in some cases can be very difficult. The device pictured near the base of the cane rotates two opposing arms (6) up to 180 degrees (7) to pickup items on the surface. The use of stainless steel, screw type, hose clamps (2) that may be unscrewed and opened far enough, without distortion, to be reattached around a cane or crutch shaft and screwed back together and tightened as required, to facilitate ease of assembly without requiring modification to the cane or crutch.

Referring to FIGS. 1 and 2 by pulling the trigger (11) the stretch resistant cord (9) rotates the two opposing cams (33), up to 180 degrees causing the two opposing arms (6) to also rotate meeting at surface level (12). A torsion spring (16) mounted behind and between the two arms, returns the arms (6) to the up (vertical) and at rest position. The cord clamp (5) does not allow the cord (9) to retract beyond the upper limit of the arms (6). When activated by the trigger (11) the cord travels thru the slot (39) FIG. 7, to pulley (18) and then to an idler pulley (17) which the idler pulley (31) is adjustable to eliminate slack or height adjustment, the cord (9) then travels up and through the pulley (19) FIG. 1, and to a hole near the end of the trigger (11). The reason for the idler pulley (17) makes it possible to secure both ends of the cord (9) at assembly and adjust tension if necessary. The device body (7) in FIG. 6 consists of two opposing cams (33) mounted on a keyed or shaft with flats (35) a cord (9) fastened to cord (41) locked together by cord clamp (32). The other end of shaft (35) has similar flats on the opposite end to locate and drive the arms (6) and are attached by (13) screws, FIG. 7 and FIG. 10, shows how the body (7) is attached to the lower adjustable portion (40) of the cane (1) by using the clamps (14) and (15). The trigger (11) is held in position by a rivet (43) to a clevis (44) that is attached to mounting bracket (8) held pivotally by a rivet (42), the mounting bracket is also designed with two mounting holes (38) and (39) that allow pin (45) to change to hole (38) in mounting bracket (8) and allow clevis (44) to be rotated 30 degrees and be used on a straight shafted cane FIG. 8, or a crutch FIG. 9. The pivot mounts FIG. 4, and FIG. 5, have recesses (28), formed into them to allow for the hose clamps to be used without interfering with the pivot mounts and still give support.

What is claimed is:

1. A body located near the cane tip, comprising of two keyed shafts in cams which are rotated up to 180 degrees by a by a cord and pulley system from the trigger, in turn, the keyed shafts rotate (up to 180 degrees) two keyed arms normally stored in the vertical, up position, to clamp on items at or near the surface and along the side of the cane tip, and away from the walker.

2. A Trigger Mounting Assembly, Pulleys and an easy method for attachment to canes or crutches using hose clamps or cable ties, to mount pivots and pulleys which allow adjustment for slack and changes in height adjustments, and the rotating grasping device. This method of using hose clamps or cable ties, allows clamping between a “V” shaped surface to clamp on many shaft diameters and even irregularly shaped shafts. The cable ties are not shown in favor of the hose clamps since the cable ties can slip, loosen or break, but their use is possible.

3. A device for attachment to a cane or crutch comprising of: a convenient trigger assembly mounted within finger reach of the walker without removing the hand from the handle giving greater gripping forces.
